(19) United States
(12) Patent Application Publication
(10) Pub. No.: US 2025/0245660 A1
(43) Pub. Date: Jul. 31, 2025

(54) DEVICE-SPECIFIC PASSKEY COMMUNICATION SYSTEMS AND TECHNIQUES

(71) Applicant: Wells Fargo Bank, N.A., San Francisco, CA (US)

(72) Inventors: Bryan D. Hall, Charlotte, NC (US); Ramakrishna Swarup Pogalur, San Ramon, CA (US); Amy Christine Ulrich, Phoenix, AZ (US); Matthew N. Wheeler, Charlotte, NC (US)

(21) Appl. No.: 18/428,764

(22) Filed: Jan. 31, 2024

(51) Int. Cl. G06Q 20/40; G06Q 20/32

(52) U.S. Cl. CPC G06Q 20/401; G06Q 20/3224; G06Q 20/3278

(57) ABSTRACT

Systems and techniques may generally be used for device-specific passkey communication. An example technique may include authenticating a customer at a banking device, determining, at the banking device, that the customer is a registered mobile app user, and retrieving, in response to determining that the customer is the registered mobile app user, a passkey paired to an account of the customer and paired to a mobile device of the customer. The example technique may include sending, from the banking device via a proximity-based communication protocol, the passkey to the mobile device of the customer.

### BACKGROUND

Security threats are an ever increasing part of interacting with online systems. Systems that rely on only a password may be vulnerable to attacks. Some secure systems rely on multi-factor authentication and other complex security techniques, although these can be cumbersome or difficult to understand for those not well versed in technology. Intimidating technological solutions can lead wary users to adopting less secure habits, negating the benefits of these solutions.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for device-specific passkey communication in accordance with some examples.

FIG. 2 illustrates a data flow diagram for device-specific passkey communication in accordance with some examples.

FIG. 3 illustrates a banker device user interface for device-specific passkey communication in accordance with some examples.

FIG. 4 illustrates a customer device user interface for device-specific passkey communication in accordance with some examples.

FIG. 5 illustrates a flowchart showing a technique for device-specific passkey communication in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein provide for device-specific passkey communication. A passkey may include a public and private key pair. A passkey may be generated at a user device, such as with a private key stored on the user device. A public key may be sent to a trusted device (e.g., a banking server via a banking device). The device-specific passkey (e.g., the private key) may be used to encrypt or decrypt information, which may be decrypted or encrypted using a public key. By generating the passkey on the user device and not sending or allowing it to leave the user device, the device-specific passkey may be more secure than a key generated and sent via a network.

In some examples, the device-specific passkey described herein may be used to replace a traditional physical device token-based authentication (e.g., RSA) or two-factor-authentication, such as for authentication. Specific authentication instances may be associated with using the device-specific passkey, such as for a transaction requiring stepped up authentication. A customer performing a high-value transfer (e.g., a large wire amount) may use a device-specific passkey as described herein to replace a traditional RSA token use to further authenticate (e.g., even after authenticating into a mobile or online system, such as an app) to approve the transaction. When the customer performs a transaction requiring the stepped-up authentication from the device, a bank system may check for the passkey or receive encrypted authentication information to bypass an RSA token or other stepped up authentication requirement.

In an example, a device-specific passkey may be a credential, such as one that is not a password (e.g., a credential such as a FIDO credential; the FIDO Alliance is an industry association). The device-specific passkey may be managed with an identity assurance platform, in some examples. A passkey may include any credential, such as a private key, that is not a password.

Example uses of a device-specific passkey include high risk or high value authentication situations, such as transactions. Some example industries for using a device-specific passkey may include banking, insurance, legal, etc. In the banking industry, for example, a device-specific passkey may be used for a premium wire, such as for a wire above $5,000, above $25,000, above $100,000, etc., for a set of wires above a cumulative amount, or the like. Other banking examples include direct pay transactions, general consumer opt-in authentication situations, mortgage signing, or the like.

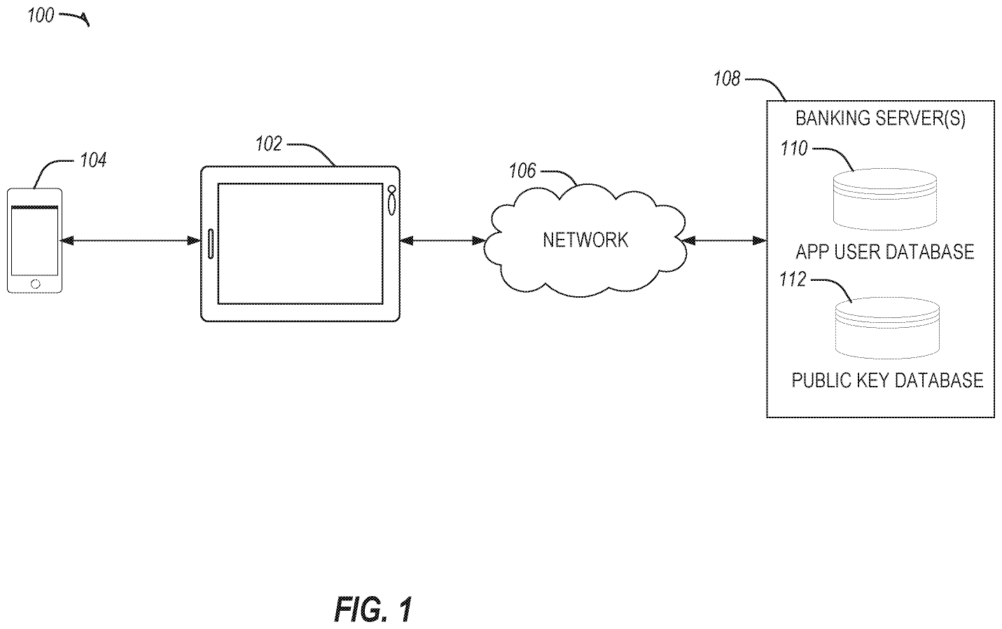

FIG. 1 illustrates a diagram of a system 100 for device-specific passkey communication in accordance with some examples. The system 100 includes banker device 102 in communication (e.g., via a proximity-based communication protocol) with a customer device 104, a network 106 (e.g., the internet), a banking server(s) 108, an app user database 110, and a public key database 112. The banking server(s) 108 may include one or more servers, such as a server hosting the app user database 110 and a server hosting the public key database 112, or may include both databases on a single server.

The banker device 102 may be used to initiate generation of a passkey on the customer device 104, such as via the network 106. The banker device 102 may communicate with the banking server(s) 108 to obtain user information from the app user database 110. For example, the app user database 110 may store information related to a prior login or authentication by a user, such as a user of the customer device 104 (optionally tied to the customer device 104 specifically). The app user database 110 may send an indication via the network 106 to the banker device 102 indicating that the customer device 104 or the user of the customer device 104 has an associated login or authentication (e.g., a username). This indication may be sent in response to a query from the banker device 102 (e.g., in response to the user asking the banker to initiate obtaining a passkey or in response to a communication, such as a proximity-based communication from the customer device 104 to the banker device 102).

A passkey may include a private key of a private and public key pair. In the examples described herein, the passkey may be stored on the customer device 104 and the public key may be stored at the banking server(s) 108, for example in the public key database 112. The public key may be encrypted before being stored in the public key database 112. The passkey may be generated at the banking server(s) 108 or at the banker device 102. In an example, the customer device 104 may communicate with the banker device 102. The communication may include a device-to-device direct communication, such as one that relies on proximity, for example NFC. In other examples, the communication may be over a network (e.g., the internet). In response to receiving the communication from the customer device 104, the banker device 102 may check credentials or authentication of the customer device 104 or a user with the banking server(s) 108. The banker device 102 may receive a passkey from the banking server(s) 108 or may generate a passkey locally at the banker device 102. The banker device 102 may send the passkey, for example via NFC, to the customer device 102 for storage. When the banker device 102 is the device that generates the passkey, the banker device 102 may also generate a public key, and send the public key to the public key database 112 for storage.

While this procedure uses a network 106, it may be a network internal to the bank, and thus in an example, the passkey does not leave the bank ecosystem. The final transmission of the passkey to the customer device 104 may be done using proximity as a security measure, preventing man in the middle attacks.

When a user of the customer device 104 wants to authenticate (e.g., to a banking app), the customer device 104 (e.g., as initiated by the app) may transmit a request encrypted via the passkey to the banking server(s) 108. The banking server(s) 108 may access the public key database 112 to decrypt the request. In some examples, after receiving a request from the customer device 104, the banking server(s) 108 may send a response encrypted with the public key, decryptable at the customer device 104 using the passkey.

In an example, when a customer enter a bank branch, the customer may request a passkey (e.g., the customer may verbally request a passkey from a banker, or the customer device 104 may send a request to the banking server(s) 108 or to the banker device 102). In response to the request, the banker device 102 may authenticate the customer or the customer device 104 (e.g., via receiving authentication verification from the banking server(s) 108 or elsewhere). The banker device 102 may verify or receive a verification that the customer is a registered mobile user in some examples. The banking server(s) 108 or the banker device 102 may generate a passkey paired to the customer device 104 and optionally to an account of the customer. The customer device 104 may then communicate with the banker device 102. The banker device 102 may include a mobile phone, a tablet, a banker PIN pad, or the like. The communication between the customer device 104 and the banker device 102 may occur using NFC or other proximate communication protocol (e.g., Bluetooth, longer range NFC, RFID, ultrawide band NFC. low energy Bluetooth, or the like). This provides security by using a direct transmission and proximity. A passkey may be transmitted the customer device 104.

In some examples, the banking server(s) 108 may suspend the public key from transactions (thus inactivating the passkey or other token) on the customer device 104. The suspension may be temporary or permanent. The suspension may occur for various reasons, such as based on a customer request, when a customer logs out of a mobile app, in response to a fraud alert related to the customer account, when the customer device 102 is lost or stolen, based on a geofence or location of the customer device 102 (e.g., only active when the customer device 102 is at some specified location, such as home or a bank branch), during a particular time period (e.g., only active during banking hours or on particular days), or the like.

When a customer performs a transaction on the customer device 104, the experience may be seamless, for example passing the passkey without the customer directly involved (e.g., automatically). When the customer attempts to perform a transaction on a different device (e.g., website accessed on a different computing device), an additional query may occur (e.g., to the customer device 104). For example, the customer may attempt a transaction on a separate device, and receive a confirmation request on the customer device 104. In response to confirming the request on the customer device 104, the passkey may be used to verify a portion of the transaction automatically. The passkey stored on the customer device 104 may be secured by one or more device-based security measures on the customer device 104. For example, the passkey may be only activated by a password, biometric, gesture, etc. (or a combination) at the customer device 104.

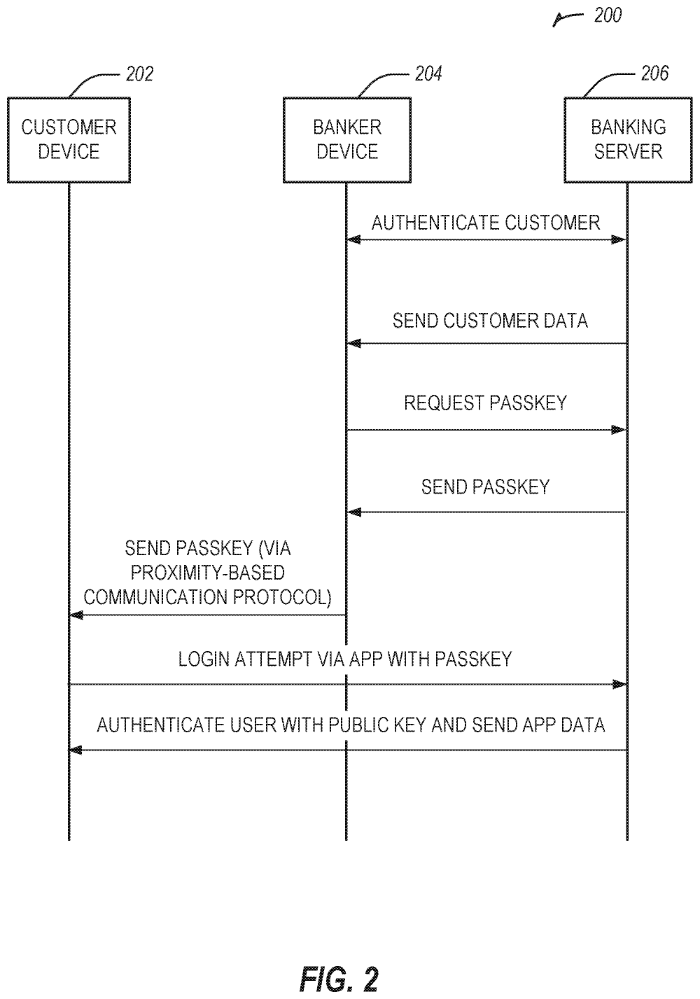

FIG. 2 illustrates a data flow diagram 200 for device-specific passkey communication in accordance with some examples. The data flow diagram 200 illustrates a customer device, 202, a banker device 204, and a banking server 206. The banker device 204 may be used to authenticate a customer (e.g., of the customer device 202) with the banking server 206. In some examples, the banker device 204 may be authenticated first with the banking server 206. After authentication, the banking server 206 may send customer data to the banker device 204. The customer data may include data related to an already existing account of the customer, for example an account number, an identifier of the customer, date of birth, address, name, etc. The banker device 204 may be used to confirm with the customer that the account customer data is correct in some examples. The banker device 204 may request a passkey from the banking server 206. The banking server 206 may send the passkey to the banker device 204. In examples not shown in FIG. 2, the banker device 204 may generate a passkey locally.

After receiving the passkey, the banker device 204 may send the passkey, for example using a proximity-based communication protocol such as NFC, to the customer device 202. The customer device 202 may after receiving the passkey (e.g., immediate, such as within a bank branch for troubleshooting or further authentication, or later, such as for a typical transaction), attempt to login via a banking app by sending information encrypted by the passkey to the banking server 206, which may use a stored key to decrypt the information. The banking server 206 may authenticate the customer with a public key and send app data to the customer device 202. In some examples, the customer device 202 may request information from the banking server 206, which may send data encrypted with a public key that is decryptable by the passkey.

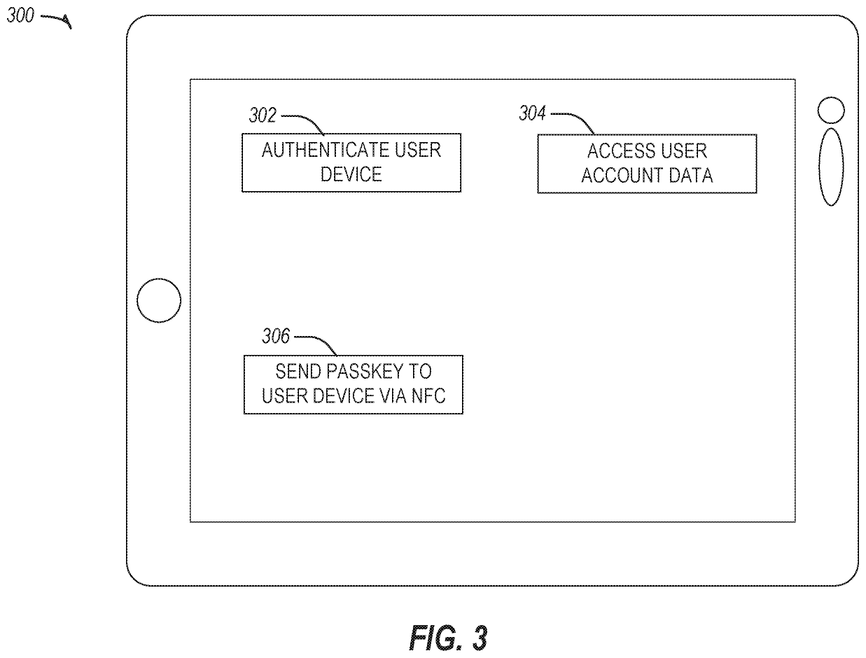

FIG. 3 illustrates a banker device user interface 300 for device-specific passkey communication in accordance with some examples. The user interface 300 may be displayed on a banker device for facilitating authentication of a user, generating or receiving a passkey for a user, as well as typical banking actions, such as displaying account details, withdrawing or depositing money, etc. The user interface 300 shown in FIG. 3 includes selectable indications, such as an authenticate user device selectable indication 302, an access user account data selectable indication 304, and a send passkey to user device via NFC selectable indication 306. These selectable indications are shown on a single user interface for convenience, but may be displayed on separate user interfaces, as part of user interfaces with other information or selectable indications, or the like.

The authenticate user device selectable indication 302 may be selected to initiate an authentication communication with an authentication server. A user may be authenticated based on biometrics, username, password, account details, etc. In some examples, selectable indications 304 and 306 may not be available until after authentication is complete.

The access user account data selectable indication 304 may be used to receive user account data, such as a username, date of birth, name, etc., which may be used for additional verification. In some examples, the access user account data selectable indication 304 may be used to request a passkey from a banking server. The passkey may be generated by the banking server as a key pair, where the banking server may store a first key and send a passkey to the banker device for communicating to a user device. In other examples, the banker device may generate the key pair locally, for example in response to a user selecting the access user account data selectable indication 304 or another menu after selection of the access user account data selectable indication 304. In these examples, the banker device may communicate a passkey to a local device (e.g., using a proximity-based communication protocol) and send a second key to a banking server or database for storage.

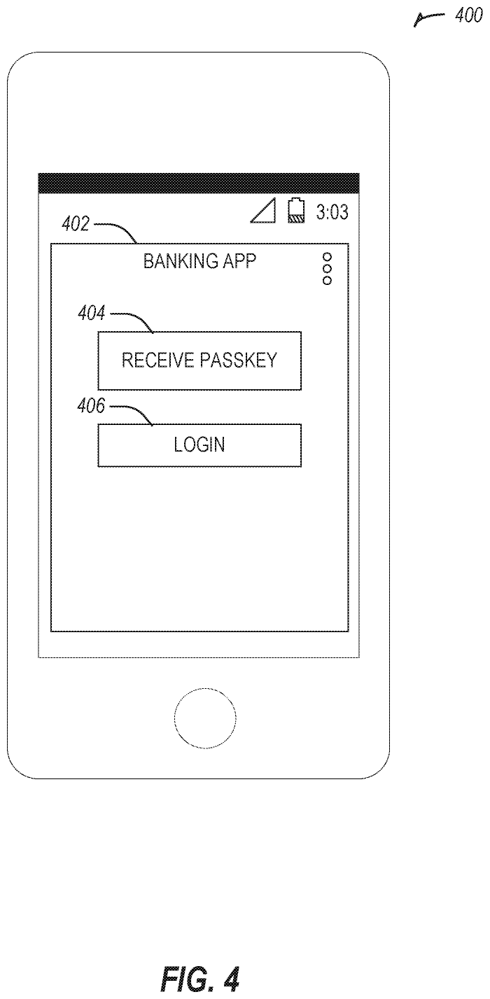

After a passkey is generated for a user device (e.g., locally by the banker device or by a remote server), the send passkey to user device via NFC selectable indication 306 may be selected to initiate a transfer of the passkey to the user device. The send passkey to user device via NFC selectable indication 306 may activate proximity-based communication circuitry at the banker device. When the user device and the banker device are within a threshold distance, the passkey may be transferred, for example via NFC, which may have a range of up to 5, 10, or 20 centimeters, depending on the particular configuration. In some examples, the user device may be set into a receiving mode (e.g., by opening a banking app, or selecting an indication on a user interface of the user device, see FIG. 4 below). The passkey may be generated according to a standard, such as according to a FIDO standard, for example as a device-bound credential. A device-bound credential is one that only can only be validated by the assigned device.

FIG. 4 illustrates a customer device 400 for device-specific passkey communication in accordance with some examples. The customer device 400 includes a user interface displaying a banking app component 402. The banking app component 402 illustrates example selectable indications, such as a receive a passkey selectable indication 404 and a login selectable indication 406.

The receive a passkey selectable indication 404 may be used to receive a passkey (e.g., from a banker device, such as is described with respect to FIGS. 1-3 above). The receive a passkey selectable indication 404 may activate NFC or other proximity-based communication circuitry at the customer device 400 to receive a passkey. In some examples, receiving the passkey may activate the login selectable indication 406. The login selectable indication 406 may be used to login to the banking app 402 (e.g., display one or more additional features of the banking app 402). The passkey may be stored in a secure enclave of the customer device 400, in some examples.

The passkey, once received at the customer device 400 may be used for one or more example transactions, such as for login, to facilitate a higher dollar money movement transaction, a digital interaction or transaction on the banking app 402, or the like. Because of the proximity-based registration process to receive the passkey, and because the passkey is locked to the customer device 402, additional security is provided by using the passkey. In some examples, a traditional limit may be increased on money movement transactions when initiated from the customer device 402 using the passkey.

In some examples, use of the banking app 402 and the passkey with the customer device 400 in a branch may authenticate a customer such that the authentication may replace traditional in person or in branch authentication. The login selectable indication 406 may be used in person or in a branch by logging into the banking app 402 and using NFC to facilitate an in person transaction with a banker device (e.g., a wire transfer, opening a new account, cashing a check, or the like).

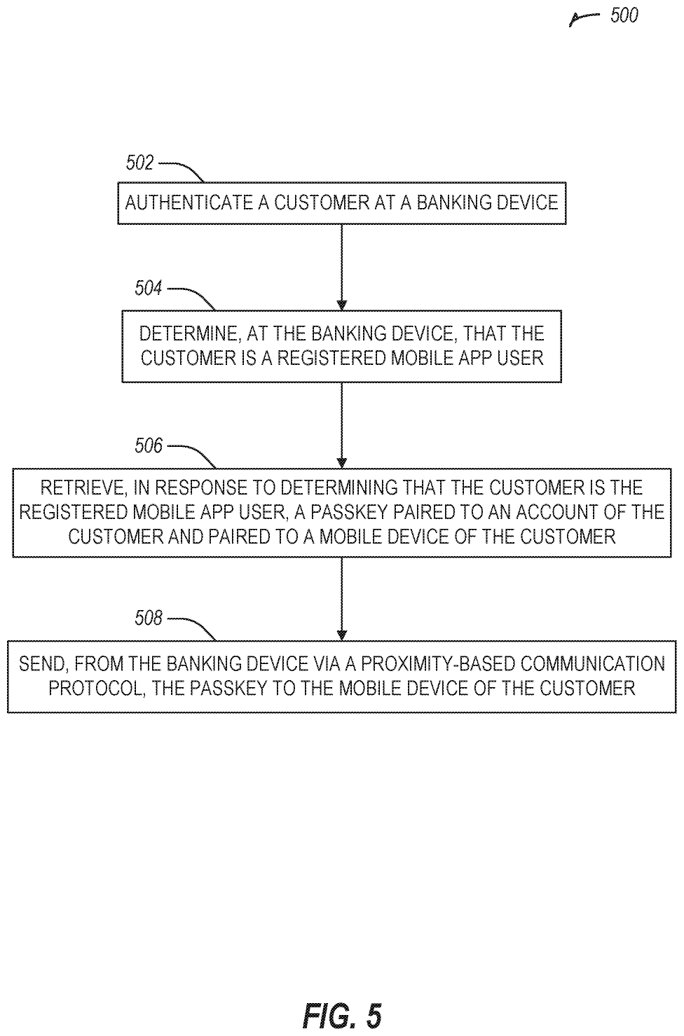

FIG. 5 illustrates a flowchart showing a technique 500 for device-specific passkey communication in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1 (e.g., the banker device 102 of FIG. 1) or 6.

The technique 500 includes an operation 502 to authenticate a customer at a banking device. The technique 500 includes an operation 504 to determine, at the banking device, that the customer is a registered mobile app user.

The technique 500 includes an operation 506 to retrieve, in response to determining that the customer is the registered mobile app user, a passkey paired to an account of the customer and paired to a mobile device of the customer. The passkey may be a device-specific passkey that is registered to the mobile device. The passkey may be configured to be used in a stepped-up authentication for a login to the account or a transaction using the account. In some examples, the passkey may be configured to conform with a FIDO (Fast IDentity Online) authentication specification, such as a FIDO Universal Second Factor (FIDO U2F) specification, a FIDO Universal Authentication Framework (FIDO UAF) specification, a Client to Authenticator Protocols (CTAP) specification, a W3C's Web Authentication (WebAuthn) specification, a FIDO2 specification, or the like.

The technique 500 includes an operation 508 to send, from the banking device via a proximity-based communication protocol, the passkey to the mobile device of the customer. In some examples, proximity-based communication protocol is a near-field communication (NFC) protocol. In other examples, the proximity-based communication protocol may include at least one of Bluetooth technologies, radio frequency identification (RFID) technologies, ultrawide band technologies (e.g., NFC), long range NFC, low energy Bluetooth, or the like. Operation 508 may include sending the passkey to the mobile device in response to determining that the mobile device has tapped the banking device.

The technique 500 may include an optional operation to receive, at the banking device, an indication from the mobile device corresponding to a transaction, the indication including the passkey. The optional operation may include authenticating the passkey with a public key stored at a banking server. The optional operation may include outputting, such as for display on the banking device, approval for the transaction in response to authenticating the passkey. In some examples, the transaction includes at least one of sending a wire transfer, opening a new account, cashing a check, or the like (e.g., a transaction typically conducted at a bank branch, such as without using a mobile device of a user).

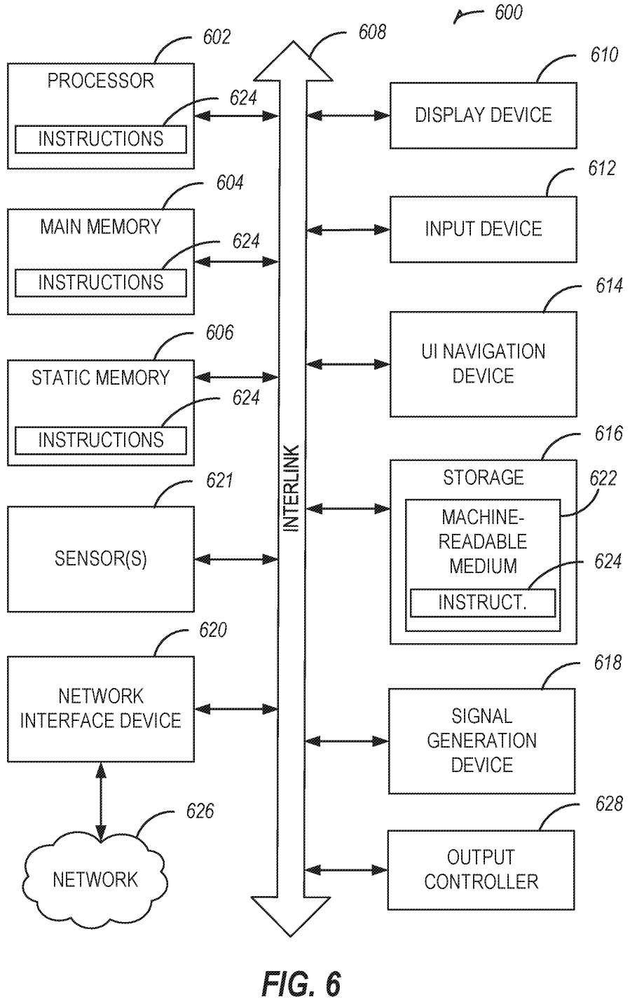

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: authenticating a customer at a banking device; determining, at the banking device, that the customer is a registered mobile app user; retrieving, in response to determining that the customer is the registered mobile app user, a passkey paired to an account of the customer and paired to a mobile device of the customer; and sending, from the banking device via a proximity-based communication protocol, the passkey to the mobile device of the customer.

In Example 2, the subject matter of Example 1 includes, wherein the proximity-based communication protocol is a near-field communication (NFC) protocol.

In Example 3, the subject matter of Examples 1-2 includes, wherein sending the passkey to the mobile device occurs in response to determining that the mobile device has tapped the banking device.

In Example 4, the subject matter of Examples 1-3 includes, wherein the passkey is a device-specific passkey that is registered to the mobile device.

In Example 5, the subject matter of Examples 1˜4 includes, wherein the passkey is configured to be used in a stepped-up authentication for a login to the account or a transaction using the account.

In Example 6, the subject matter of Examples 1-5 includes, wherein the passkey conforms with a FIDO (Fast IDentity Online) authentication specification.

In Example 7, the subject matter of Examples 1-6 includes, receiving, at the banking device, an indication from the mobile device corresponding to a transaction, the indication including the passkey; authenticating the passkey with a public key stored at a banking server; and outputting, for display on the banking device, approval for the transaction in response to authenticating the passkey.

In Example 8, the subject matter of Example 7 includes, wherein the transaction includes at least one of sending a wire transfer, opening a new account, or cashing a check.

In Example 9, the subject matter of Examples 1-8 includes, wherein the proximity-based communication protocol includes at least one of Bluetooth technologies, radio frequency identification (RFID) technologies, or ultrawide band technologies.

Example 10 is at least one non-transitory machine-readable medium including instructions, which when executed by processing circuitry of a banking device, cause the processing circuitry to perform operations to: authenticate a customer at the banking device; determine, at the banking device, that the customer is a registered mobile app user; identify, in response to determining that the customer is the registered mobile app user, a passkey paired to an account of the customer and paired to a mobile device of the customer; and send, from the banking device via a proximity-based communication protocol, the passkey to the mobile device of the customer.

In Example 11, the subject matter of Example 10 includes, wherein the proximity-based communication protocol is a near-field communication (NFC) protocol.

In Example 12, the subject matter of Examples 10-11 includes, wherein operations to send the passkey to the mobile device occur in response to determining that the mobile device has tapped the banking device.

In Example 13, the subject matter of Examples 10-12 includes, wherein the passkey is a device-specific passkey that is registered to the mobile device.

In Example 14, the subject matter of Examples 10-13 includes, wherein the passkey is configured to be used in a stepped-up authentication for a login to the account or a transaction using the account.

In Example 15, the subject matter of Examples 10-14 includes, wherein the passkey conforms with a FIDO (Fast IDentity Online) authentication specification.

In Example 16, the subject matter of Examples 10-15 includes, wherein the operations further cause the processing circuitry to: receive, at the banking device, an indication from the mobile device corresponding to a transaction, the indication including the passkey; authenticate the passkey with a public key stored at a banking server; and output, for display on the banking device, approval for the transaction in response to authenticating the passkey.

In Example 17, the subject matter of Example 16 includes, wherein the transaction includes at least one of sending a wire transfer, opening a new account, or cashing a check.

In Example 18, the subject matter of Examples 10-17 includes, wherein the proximity-based communication protocol includes at least one of Bluetooth technologies, radio frequency identification (RFID) technologies, or ultrawide band technologies.

Example 19 is a system comprising: a banking server configured to: store a passkey and a corresponding public key; and store a list of registered mobile app users; and a banking device configured to: authenticate a customer; determine that the customer is a registered mobile app user by querying the banking server; retrieve, in response to determining that the customer is the registered mobile app user, the passkey from the banking server, the passkey paired to an account of the customer and paired to a mobile device of the customer; and send, from the banking device via a proximity-based communication protocol, the passkey to the mobile device of the customer.

In Example 20, the subject matter of Example 19 includes, wherein the proximity-based communication protocol is a near-field communication (NFC) protocol.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
authenticating a customer at a banking device;
determining, at the banking device, that the customer is a registered mobile app user;
retrieving, in response to determining that the customer is the registered mobile app user, a passkey paired to an account of the customer and paired to a mobile device of the customer; and
sending, from the banking device via a proximity-based communication protocol, the passkey to the mobile device of the customer.

2. The method of claim 1, wherein the proximity-based communication protocol is a near-field communication (NFC) protocol.

3. The method of claim 1, wherein sending the passkey to the mobile device occurs in response to determining that the mobile device has tapped the banking device.

4. The method of claim 1, wherein the passkey is a device-specific passkey that is registered to the mobile device.

5. The method of claim 1, wherein the passkey is configured to be used in a stepped-up authentication for a login to the account or a transaction using the account.

6. The method of claim 1, wherein the passkey conforms with a FIDO (Fast IDentity Online) authentication specification.

7. The method of claim 1, further comprising:
receiving, at the banking device, an indication from the mobile device corresponding to a transaction, the indication including the passkey;
authenticating the passkey with a public key stored at a banking server; and
outputting, for display on the banking device, approval for the transaction in response to authenticating the passkey.

8. The method of claim 7, wherein the transaction includes at least one of sending a wire transfer, opening a new account, or cashing a check.

9. The method of claim 1, wherein the proximity-based communication protocol includes at least one of Bluetooth technologies, radio frequency identification (RFID) technologies, or ultrawide band technologies.

10. At least one non-transitory machine-readable medium including instructions, which when executed by processing circuitry of a banking device, cause the processing circuitry to perform operations to:
authenticate a customer at the banking device;
determine, at the banking device, that the customer is a registered mobile app user;
identify, in response to determining that the customer is the registered mobile app user, a passkey paired to an account of the customer and paired to a mobile device of the customer; and
send, from the banking device via a proximity-based communication protocol, the passkey to the mobile device of the customer.

11. The at least one non-transitory machine-readable medium of claim 10, wherein the proximity-based communication protocol is a near-field communication (NFC) protocol.

12. The at least one non-transitory machine-readable medium of claim 10, wherein operations to send the passkey to the mobile device occur in response to determining that the mobile device has tapped the banking device.

13. The at least one non-transitory machine-readable medium of claim 10, wherein the passkey is a device-specific passkey that is registered to the mobile device.

14. The at least one non-transitory machine-readable medium of claim 10, wherein the passkey is configured to be used in a stepped-up authentication for a login to the account or a transaction using the account.

15. The at least one non-transitory machine-readable medium of claim 10, wherein the passkey conforms with a FIDO (Fast IDentity Online) authentication specification.

16. The at least one non-transitory machine-readable medium of claim 10, wherein the operations further cause the processing circuitry to:
receive, at the banking device, an indication from the mobile device corresponding to a transaction, the indication including the passkey;
authenticate the passkey with a public key stored at a banking server; and
output, for display on the banking device, approval for the transaction in response to authenticating the passkey.

17. The at least one non-transitory machine-readable medium of claim 16, wherein the transaction includes at least one of sending a wire transfer, opening a new account, or cashing a check.

18. The at least one non-transitory machine-readable medium of claim 10, wherein the proximity-based communication protocol includes at least one of Bluetooth technologies, radio frequency identification (RFID) technologies, or ultrawide band technologies.

19. A system comprising:
a banking server configured to:
store a passkey and a corresponding public key; and
store a list of registered mobile app users; and
a banking device configured to:
authenticate a customer;
determine that the customer is a registered mobile app user by querying the banking server;
retrieve, in response to determining that the customer is the registered mobile app user, the passkey from the banking server, the passkey paired to an account of the customer and paired to a mobile device of the customer; and
send, from the banking device via a proximity-based communication protocol, the passkey to the mobile device of the customer.

20. The system of claim 19, wherein the proximity-based communication protocol is a near-field communication (NFC) protocol.
